(19) United States
(12) Patent Application Publication
(10) Pub. No.: US 2008/0194329 A1
(43) Pub. Date: Aug. 14, 2008

(54) Method And Apparatus For Gaming Machine Peripherals

(76) Inventors: Mark V. Page, East Chicago, IN (US); Stephen A. Canterbury, Antioch, IL (US); Victor Mercado, Berwyn, IL (US)

Correspondence Address: SCHWEGMAN, LUNDBERG & WOESSNER, P.A., P.O. BOX 2938, MINNEAPOLIS, MN, 55402, US

(21) Appl. No.: 11/572,114

(22) PCT Filed: Sep. 19, 2005
(86) PCT No.: PCT/US05/33592

§ 371 Date: Jan. 15, 2007

Related U.S. Application Data
(60) Provisional application No. 60/613,990, filed on Sep. 28, 2004.

(51) Int. Cl. A63F 9/24; G06F 17/00

(52) U.S. Cl. 463/37; 463/20; 707/201

(57) ABSTRACT

A method and apparatus for gaming machine peripherals are described herein. In one embodiment, the method is performed by a smart component of a multipart gaming machine peripheral. In one embodiment, the method comprises establishing communication with a gaming machine master processing unit. The method also includes determining that a dumb component of the multipart gaming machine peripheral is connected and operating properly, wherein the dumb component does not include a processor. The method also includes controlling the dumb component of the multipart gaming machine peripheral, wherein the controlling is performed by a peripheral processor included in the smart component. The method also includes determining that the dumb component is not connected or not operating properly, and upon determining that the dumb component is not connected or not operating properly, maintaining the communication with the gaming machine master processing unit.

### RELATED APPLICATION

This application claims the priority benefit of U.S. Provisional Application Ser. No. 60/613,990 filed Sep. 28, 2004, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of gaming machines and more particularly to gaming machine peripheral devices.

### BACKGROUND

There are a wide variety of peripheral devices that can be connected to gaming machines. These peripheral devices provide features that define or augment games presented on the gaming machines. Peripheral devices used in conjunction with gaming machines include coin mechanisms, lights, printers, card readers, speakers, bill validators, display panels, keypads, button pads, etc.

In the past, a “master gaming controller” controlled a gaming machine's peripheral devices. For example, when controlling a bill validator, the master gaming controller performed peripheral device control operations, such as instructing the bill validator to activate its motor and wheels to accept paper currency, instructing the bill validator to begin scanning the paper currency, and processing scan data to determine whether the currency is valid. In order for the master gaming processor to communicate with and control peripheral devices, the peripheral devices were wired directly into the gaming machine's motherboard. Therefore, replacing a gaming machine peripheral was relatively difficult.

Because gaming machine peripherals provide sophisticated services, such as bill validation, they demanded vast amounts of processing time from master gaming processors. In order to reduce processing demands on master gaming processors, peripheral devices were equipped with their own microcontrollers. The peripheral microcontrollers were connected to gaming machines using standard plug-and-play connections, such as Universal Serial Bus (USB) connections.

FIG. 1 is a block diagram illustrating a prior art connection between a gaming machine and a unified gaming machine peripheral device. FIG. 1 shows a unified gaming machine peripheral 108 that includes controllable machinery 114, which is connected to a local peripheral processing unit 112. The local peripheral processing unit 112 is connected to a plug-and-play peripheral-device-side connector 110. In the unified gaming machine peripheral 108, the local peripheral processing unit 112 controls the controllable machinery 114 and performs any data processing necessary for performing peripheral device functions (e.g., bill validation functions). The controllable machinery 114 can include mechanical and/or electromechanical components, such as gears, levers, servos, transducers, etc. The controllable machinery 114 performs mechanical/electromechanical functions, such as accepting and scanning currency, coins, credit cards, etc.

The plug-and-play peripheral-device-side connector 110 is connectable to a plug-and-play capable gaming-machine-side connector 106. The plug-and-play capable gaming-machine-side connector 106, which is part of a gaming machine cabinet 102, is connected to a gaming machine master processing unit 104. The gaming machine master processing unit 104 performs all processing necessary for presenting a casino style game (e.g., slots, roulette, poker, blackjack, etc.). Although the gaming machine master processing unit 104 communicates with the unified gaming machine peripheral 108 (through the connectors 106 and 110), it does not control the peripheral's controllable machinery 114 or perform the peripheral's data processing.

One disadvantage of the plug-and-play capable unified gaming machine peripheral 108 is that it cannot be blindly mated to the gaming machine cabinet 102 via the plug-and-play capable gaming-machine-side connector 106. That is, the unified gaming machine peripheral 108 must be visually guided into connection with the gaming machine cabinet 102.

Another disadvantage of the unified gaming machine peripheral 108 is that it is relatively expensive to repair. For example, because the local peripheral processing 112 and control machinery 114 are permanently connected together, neither component can be independently replaced. Thus, both components are typically replaced when only one is broken.

Yet another disadvantage of the unified gaming machine peripheral 108 is that critical state information (e.g., information about bill validation transactions) may be lost when replacing the controllable machinery 114. When replacing the controllable machinery 114, power flow to the peripheral is typically terminated. When the peripheral 108 loses power, the local peripheral processing unit 112 may loose its state information. For example, if the unified gaming machine peripheral 108 is powered-down during a bill validation transaction (e.g., because of a paper jam), the local peripheral processing unit 112 could loose track of the transaction state. As a result, the gaming machine may not “remember” that it received paper currency before loosing power.

### SUMMARY

A method and apparatus for gaming machine peripherals are described herein. In one embodiment, the method is performed by a smart component of a multipart gaming machine peripheral. In one embodiment, the method comprises establishing communication with a gaming machine master processing unit. The method also includes determining that a dumb component of the multipart gaming machine peripheral is connected and operating properly, wherein the dumb component does not include a processor. The method also includes controlling the dumb component of the multipart gaming machine peripheral, wherein the controlling is performed by a peripheral processor included in the smart component. The method also includes determining that the dumb component is not connected or not operating properly, and upon determining that the dumb component is not connected or not operating properly, maintaining the communication with the gaming machine master processing unit.

### BRIEF DESCRIPTION OF THE FIGURES

The present invention is illustrated by way of example and not limitation in the Figures of the accompanying drawings in which:

FIG. 1 is a block diagram illustrating a prior art connection between a gaming machine and a unified gaming machine peripheral device;

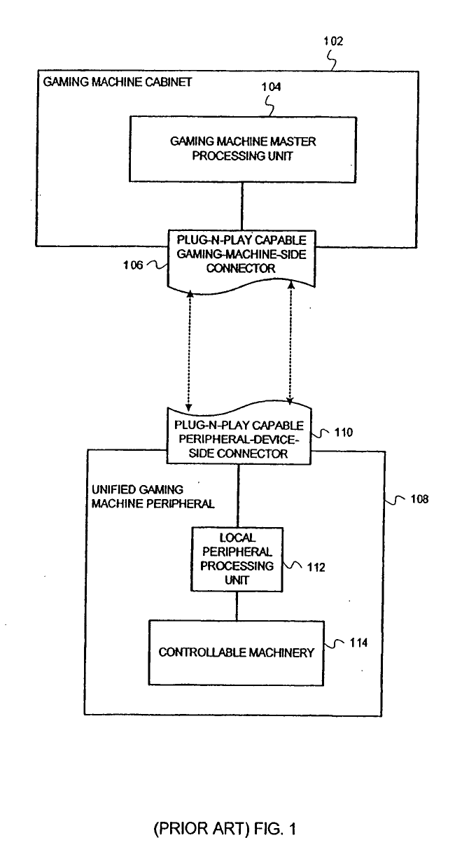

FIG. 2 is a block diagram illustrating a multipart gaming peripheral device, according to an exemplary embodiment of the invention;

FIG. 3 is a block diagram illustrating a multipart gaming machine peripheral device connected to a gaming machine cabinet;

FIG. 4 is flow diagram illustrating operations for establishing communications with a gaming machine master processing unit, according to exemplary embodiments of the invention;

FIG. 5 is a flow diagram illustrating operations for establishing communications with a multipart gaming machine peripheral device, according to exemplary embodiments of the invention; and

FIG. 6 is a perspective view of a gaming device, according to exemplary embodiments of the invention.

### DESCRIPTION OF THE EMBODIMENTS

Methods and apparatus for gaming machine peripherals are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

### System Architecture

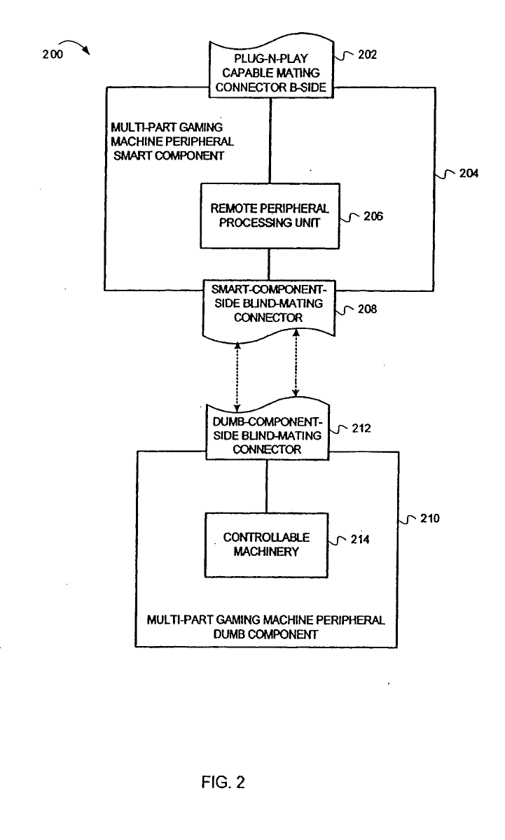

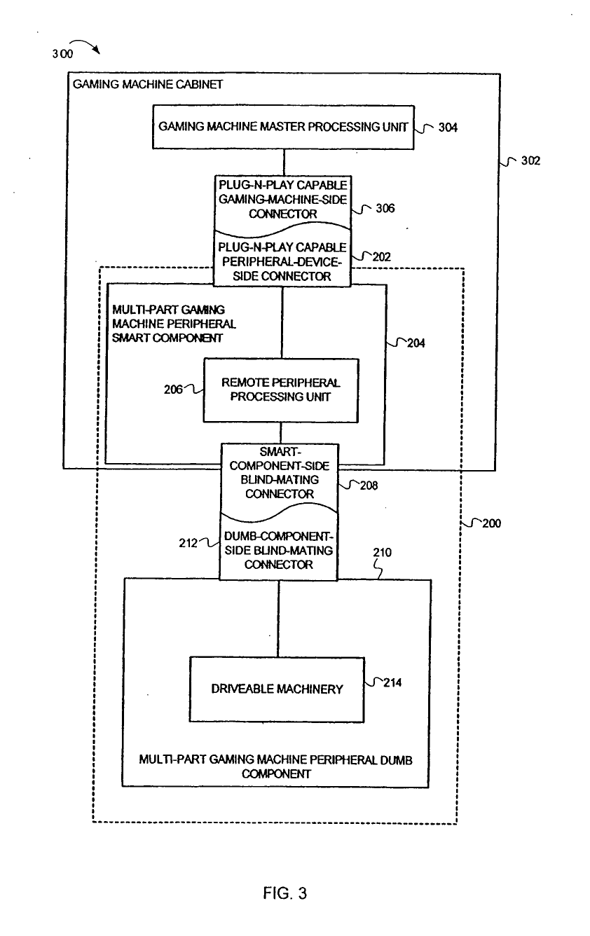

This section will describe a multipart gaming machine peripheral architecture. In the following discussion, FIG. 2 will describe a multipart gaming machine peripheral device, while FIG. 3 will describe the multipart machine peripheral device connected to a gaming machine master processing unit.

FIG. 2 is a block diagram illustrating a multipart gaming peripheral device, according to an exemplary embodiment of the invention. FIG. 2 shows a multipart gaming machine peripheral device 200. The multipart gaming machine peripheral device 200 includes a multipart gaming machine peripheral dumb component 210, which includes controllable machinery 214. The controllable machinery 214 is connected to a dumb-component-side blind-mating connector 212. The controllable machinery 214 includes electromechanical components (e.g., levers, servos, solenoids, gears, etc) for performing operations such as accepting currency, printing tickets, accepting player input, etc.

The multipart gaming machine peripheral smart component 204 includes a smart-component-side blind-mating connector 208. The smart-component-side blind-mating connector 208 and the dumb-component-side blind-mating connector 212 provide a physical interface between the multipart gaming machine peripheral smart component 204 and the multipart gaming machine peripheral dumb component 210. The blind-mating connectors 208 and 212 can blindly mate together, forming a communication path between the smart and dumb components 204 and 210. That is, the blind-mating connectors 208 and 212 can be connected without visually guiding the components together.

The multipart gaming machine peripheral smart component 204 also includes a remote peripheral processing unit 206, which is connected to the smart-component-side blind-mating connector 208. The remote peripheral processing unit 206, which is remotely located from the multipart gaming machine peripheral dumb component 210, can control electromechanical operations performed by the controllable machinery 214. The remote peripheral processing unit 206 can also perform data processing necessary for carrying out the peripheral's functionality (e.g., performing data processing for bill validation). In one embodiment, the remote peripheral processing unit can control several different types of peripheral dumb components and controllable machinery (e.g., bill validators, card readers, etc.). In one embodiment, the remote peripheral processing unit 206 can control more than one peripheral dumb component. For example, the remote peripheral processing unit can connect with (via smart-component-side blind-mating connectors) and control a plurality of dumb peripheral components. In certain embodiments, the remote peripheral processing unit 206 includes one or more switches, jumpers, and/or other programmable logic, which can be modified to configure the unit 206 to perform various operations. Additionally, an active or passive feedback scheme can be used to configure the peripheral processing unit 206.

The remote peripheral processing unit 206 is connected to a plug-and-play peripheral-device-side connector 202, which connects the multipart gaming machine peripheral device 200 to a gaming machine cabinet. The plug-and-play peripheral-device-side connector 202 can support any plug-and-play peripheral communication interface protocol, such as USB and firewire (i.e., IEEE 1394).

From the discussion above, it should be apparent that the multipart gaming machine peripheral 200 is divided into two components, where the remote peripheral processing unit 206 is separate from the controllable machinery 214. While FIG. 2 describes a multipart gaming machine peripheral device, FIG. 3 describes connecting the multipart gaming machine peripheral device to a gaming machine cabinet.

FIG. 3 is a block diagram illustrating a multipart gaming machine peripheral device connected to a gaming machine cabinet. In FIG. 3, the smart and dumb components of the multipart gaming machine peripheral device 200 are connected via the blind-mating connectors 208 and 212. FIG. 3 also shows a gaming machine 300 including a gaming machine cabinet 302. The gaming machine cabinet 302 includes a gaming machine master processing unit 304 connected to a plug-and-play capable gaming-machine-side connector 306. The gaming machine cabinet 302 and the multipart peripheral device 200 are connected via the plug-and-play capable gaming-machine-side connector 306 and the peripheral's plug-and-play peripheral-device-side connector 202.

Although the multipart gaming machine peripheral component 210 is connected to the gaming machine cabinet 302 via the connectors 306 and 202, it can be easily separated and removed from the gaming machine 300. In particular, the multipart gaming machine peripheral dumb component 210 can be removed from the gaming machine cabinet 302 by disconnecting the dumb-component-side blind-mating connector 212 from the smart-component-side blind-mating connector 208. Because the dumb component 210 can be removed independently of the smart component 204, the driveable machinery 214 can be replaced without disconnecting the gaming machine master processing unit 304 from the remote peripheral processing unit 206. By maintaining the connection, the peripheral processing unit 206 can continuously receive power (via connectors 306 and 202, in one embodiment) from the gaming machine cabinet 302 (gaming machine power supply not shown). As a result, the remote peripheral processing unit 206 can track peripheral state information while the drivable machinery 214 is detached.

### System Operations

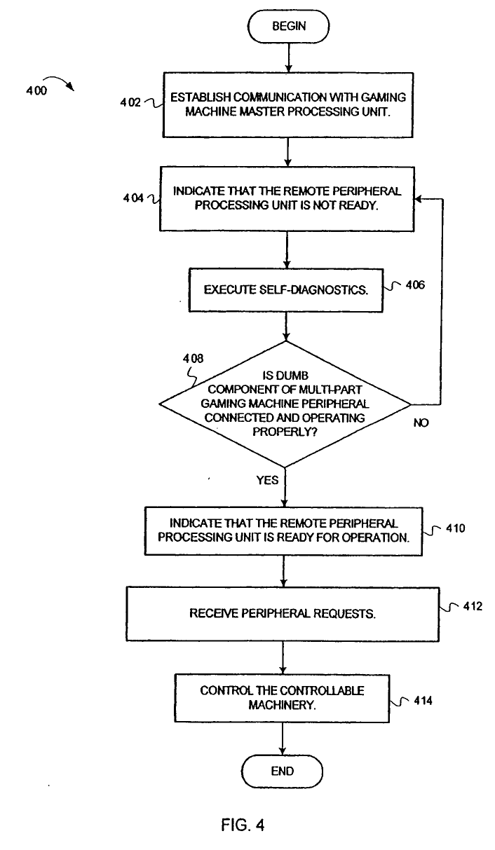

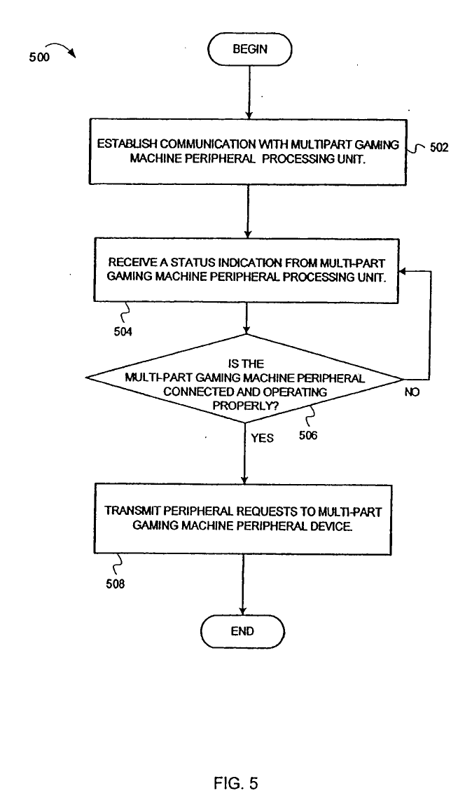

This section describes operations performed by a multipart gaming machine peripheral and components of a gaming machine cabinet. FIG. 4 will describe operations for establishing communications with a gaming machine master processing unit, while FIG. 5 will describe operations for controlling a multipart gaming machine peripheral device.

FIG. 4 is flow diagram illustrating operations for establishing communications with a gaming machine master processing unit, according to exemplary embodiments of the invention. Operations of the flow diagram can be performed when a gaming machine is powered-on. The flow diagram 400 will be described with reference to the gaming machine cabinet 302 and multipart gaming machine peripheral 200 of FIG. 300. The flow diagram 400 commences at block 402.

At block 402, communications are established with a gaming machine master processing unit. For example, the remote peripheral processing unit 206, which is part of the multipart gaming machine peripheral smart component 204, establishes communications with the gaming machine master processing unit 304 through the plug-and-play capable connectors 306 and 202. According to embodiments, the remote peripheral processing unit 206 can use packets, signals, or other suitable communication methods to establish communications with the gaming machine master processing unit 304. The flow continues at block 404.

At block 404, the remote peripheral processing unit indicates that it is not ready for operation. For example, the remote peripheral processing unit 206 transmits a communication packet to the machine master processing unit 304 indicating that it is not ready for operation. The flow continues at block 406.

At block 406, self-diagnostics are executed. For example, during initialization, the multipart gaming machine peripheral 200 executes self-diagnostics. The self-diagnostics can include operations for verifying that all peripheral components are present an operational. Additionally, the self-diagnostics can include operations for verifying that no peripheral components have been tampered with and/or modified. The flow continues at block 408.

At block 408, it is determined whether the dumb component of the multipart gaming machine peripheral is connected and operating properly. For example, the remote peripheral processing unit 206 determines whether the multipart in machine peripheral dumb component 210 is operating properly. If the dumb component 210 is not operating properly, the flow continues at block 404. Otherwise, the flow continues at block 410.

At block 410, the remote peripheral processing unit indicates that it is ready for operation. For example, the remote peripheral processing unit 206 transmits an indication to the gaming machine master processing unit 304 that it is ready for operation. The flow continues at block 412.

At block 412, peripheral requests are received. For example, the remote peripheral processing unit 206 receives requests from the gaming machine master processing unit 204. In one embodiment, remote peripheral processing unit 206 can receive requests to perform various services for the gaming machine master processing unit. For example, the remote peripheral processing unit 206 may receive a request to print a ticket. In one embodiment, although the gaming machine master processing unit 204 requests that the peripheral perform various operations, it cannot not control the peripheral's controllable machinery 214. In one embodiment, the operation at block 412 is omitted because the multipart gaming machine peripheral 200 does not receive requests from the gaming machine master processing unit 304. The flow continues at block 414.

At block 414, controllable machinery is controlled. For example, the remote peripheral processing unit 206 controls the controllable machinery 214. If the multipart peripheral 200 is a bill validator, the remote peripheral processing unit 206 can control the controllable machinery 214 to perform various bill validating functions, such as accepting and scanning paper currency. From block 414, the flow ends.

FIG. 5 is a flow diagram illustrating operations for establishing communications with a multipart gaming machine peripheral device, according to exemplary embodiments of the invention. The flow diagram 500 will be described with reference to the gaming machine cabinet 302 and multipart gaming machine peripheral 200 of FIG. 300. The flow diagram begins at block 502.

At block 502, communications are established with a multipart gaming machine peripheral processing unit. For example, the gaming machine master processing unit 304 establishes communications with the multipart gaming machine peripheral device's remote peripheral processing unit 206. The flow continues at block 504.

At block 504, a status indication is received from a remote peripheral processing unit. For example, the gaming machine master processing unit 304 receives a status indication from the remote peripheral processing unit 206. The flow continues at block 506.

At block 506, it is determined whether the multipart gaming machine peripheral is connected and operating properly. For example, the gaming machine master processing unit 304 determines whether the multipart gaming machine peripheral 200 is connected and operating properly. If the multipart gaming machine peripheral is connected and operating properly, the flow continues at block 508. Otherwise, the flow continues at block 504.

At block 508, peripheral requests are transmitted to the multipart gaming machine peripheral device. For example, the gaming machine master processing unit 304 transmits peripheral requests to the remote peripheral processing unit 206.

In one embodiment, the peripheral requests can be requests to validate currency, accept coins, print tickets, etc. From block 508, the flow ends.

### Exemplary Gaming Machine

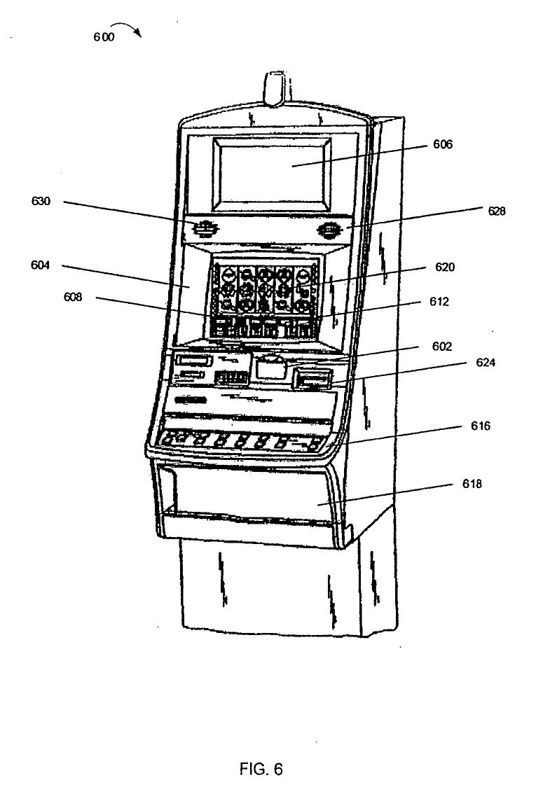

FIG. 6 is a perspective view of a gaming machine used in conjunction with embodiments of the invention. As shown in FIG. 6, the gaming machine 600 can be a slot machine having the controls, displays, and features of a conventional slot machine. The gaming machine 600 can be operated while players are standing or seated. Additionally, the gaming machine 600 is preferably mounted on a console. However, it should be appreciated that the gaming machine 600 can be constructed as a pub-style tabletop game (not shown), which a player can operate while sitting. Furthermore, the gaming machine 600 can be constructed with varying cabinet and display designs. The gaming machine 600 can incorporate any primary game such as slot, poker, or keno, and additional bonus round games. The symbols and indicia used on and in the gaming machine 600 can take mechanical, electrical or video form.

As illustrated in FIG. 6, the gaming machine 600 includes a coin slot 602 and bill acceptor 624. Players can place coins in the coin slot 602 and paper money or ticket vouchers in the bill acceptor 624. Other devices can be used for accepting payment. For example, credit/debit card readers/validators can be used for accepting payment. Additionally, the gaming machine 600 can perform electronic funds transfers and financial transfers to procure monies from house financial accounts. When a player inserts money in the gaming machine 600, a number of credits corresponding to the amount deposited are shown in a credit display. After depositing the appropriate amount of money, a player can begin playing the game by pushing play button 608. The play button 608 can be any play activator used by the player to start a game or sequence of events in the gaming machine 600.

As shown in FIG. 6, the gaming machine 600 also includes a bet display 612 and a “bet one” button 616. The player places a bet by pushing the bet one button 616. The player can increase the bet by one credit each time the player pushes the bet one button 616. When the player pushes the bet one button 616, the number of credits shown in the credit display 606 decreases by one, and the number of credits shown in the bet display 612 increases by one.

A player may “cash out” by pressing a cash out button. When a player cashes out, the gaming machine 600 dispenses a number of coins, corresponding to the number of remaining credits, into the coin tray 618. The gaming machine 600 may employ other payout mechanisms such as credit slips, which are redeemable by a cashier, or electronically recordable cards, which track player credits.

The gaming machine 600 also includes one or more display devices. The embodiment shown in FIG. 6 includes a primary display unit 604 and a secondary display unit 606. In one embodiment, the primary display unit 604 displays a plurality of reels 620. In one embodiment, the gaming machine displays three reels, while an alternative embodiment displays five reels. In one embodiment, the reels are in video form. According to embodiments of the invention, the display units can display any visual representation or exhibition, including moving physical objects (e.g., mechanical reels and wheels), dynamic lighting, and video images. In one embodiment, each reel 620 includes a plurality of symbols such as bells, hearts, fruits, numbers, letters, bars or other images, which correspond to a theme associated with the gaming machine 600. Furthermore, as shown in FIG. 6, the gaming machine 600 includes a primary sound unit 628 and a secondary sound unit 630. In one embodiment, the primary and secondary sound units include speakers or other suitable sound projection devices. The gaming machine 600 can be adapted to include the system 600. Additionally, the gaming machine 600 is capable of performing the operations for processing game settings described herein.

1. A method performed by a smart component of a multipart gaming machine peripheral comprising:
establishing communication with a gaming machine master processing unit;
determining that a dumb component of the multipart gaming machine peripheral is connected and operating properly, wherein the dumb component does not include a processor;
controlling the dumb component of the multipart gaming machine peripheral, wherein the controlling is performed by a peripheral processor included in the smart component;
determining that the dumb component is not connected or not operating properly; and
upon determining that the dumb component is not connected or not operating properly, maintaining the communication with the gaming machine master processing unit.

2. The method of claim 1, further comprising:
receiving peripheral control instructions from the gaming machine master processing unit, wherein the controlling the dumb component is based on the peripheral control instructions.

3. The method of claim 1, further comprising:
after determining that the dumb component is connected and operating properly, transmitting an indication that the dumb component is operating properly to the gaming machine master processing unit; and
upon determining that the dumb component of the multipart gaming machine peripheral is not connected and operating properly, transmitting an indication that the dumb component is not operating properly to the gaming machine master processing unit.

4. The method of claim 1, wherein the peripheral processor includes programmable logic that can be modified to perform any of a set of operations.

5. The method of claim 1, wherein the peripheral processor includes switches, jumpers, or programmable logic for configuring the peripheral processor.

6. The method of claim 1, wherein the communication of the smart component with the gaming machine master processing unit is performed using a Universal Serial Bus (USB) protocol or an IEEE 1394 (Firewire) protocol.

7. The method of claim 1, wherein the communication of the smart component with the gaming machine master processing unit is performed using any plug-and-play capable data communication protocol.

8. The method of claim 1, wherein the dumb component can be blind-mated to the smart component.

9. The method of claim 1, wherein the multipart gaming machine peripheral is selected from the group including bill validators, coin hoppers, and coin mechanisms, printers, bill dispensers, bill hoppers, display devices, and cameras.

10. The method of claim 1, wherein the dumb component can be detached from the smart component for maintenance.

11. A method performed by a gaming machine master processing unit comprising:
establishing communication with a multipart gaming machine peripheral, wherein the multipart gaming machine peripheral includes a smart component and a detachable dumb component, wherein the smart component includes a peripheral processor, and wherein the detachable dumb component does not include a processor; and
maintaining communication with the multipart gaming machine peripheral when the dumb component is detached from the smart component.

12. The method of claim 11 further comprising:
receiving a peripheral status indicator from the peripheral processor;
determining, based on the peripheral status indicator, whether the multipart gaming machine peripheral is operating properly;
if the multipart gaming machine peripheral is operating properly, transmitting peripheral requests the peripheral processor.

13. The method of claim 11, wherein the multipart gaming machine peripheral includes a bill validator.

14. A multipart gaming machine peripheral device comprising:
a detachable dumb component, wherein the detachable dumb component does not include a processor, and wherein the detachable dumb component includes,
a set of controllable machinery; and
a first blind-mating connector coupled to the set of controllable machinery; and
a smart component including,
a peripheral processor for controlling the set of controllable machinery;
a second blind-mating connector for connecting to the first blind-mating connector; and
a first plug-and-play capable connector for connecting to second a plug-and-play capable connector, wherein the second plug-and-play capable connector is electronically coupled to a gaming machine master processing unit.

15. The multipart gaming machine peripheral of claim 14, wherein the set of controllable machinery can include gears, pulleys, belts, motors, shafts, sprockets, actuators, and transducers.

16. The multipart gaming machine peripheral of claim 14, wherein the first and second blind-mating connectors are drawer connectors.

17. A gaming machine system comprising:
a gaming machine master processing unit including a plug-and-play capable data port; and
a multipart gaming machine peripheral including,
at least one detachable dumb component, wherein the detachable dumb component does not include its own processor, and wherein the detachable dumb component includes,
a set of controllable machinery that can include gears, pulleys, belts, motors, shafts, sprockets, actuators, and transducers; and
a first blind-mating connector coupled to the set of controllable machinery; and
a smart component including,
a peripheral processor for controlling the set of controllable machinery;
a second blind-mating connector for connecting to the first blind-mating connector; and
a first plug-and-play capable connector for connecting to second plug-and-play capable connector, wherein the second plug-and-play capable connector is electronically coupled to the plug-and-play capable data port.

18. The gaming machine system of claim 17, wherein the multipart gaming machine peripheral is selected from the group including bill validators, coin hoppers, and coin mechanisms, printers, bill dispensers, bill hoppers, display devices, and cameras.

19. A machine-readable medium including instructions which when executed by a smart component of a multipart gaming machine peripheral perform operations comprising:
establishing communication with a gaming machine master processing unit;
determining that a dumb component of the multipart gaming machine peripheral is connected and operating properly, wherein the dumb component does not include a processor;
controlling the dumb component of the multipart gaming machine peripheral, wherein the controlling is performed by a peripheral processor included in the smart component;
determining that the dumb component is not connected or not operating properly; and
upon determining that the dumb component is not connected or not operating properly, maintaining the communication with the gaming machine master processing unit.

20. The machine-readable medium of claim 19, further comprising:
receiving peripheral control instructions from the gaming machine master processing unit, wherein the controlling the dumb component is based on the peripheral control instructions.

21. The machine-readable medium of claim 19, further comprising:
after determining that the dumb component is connected and operating properly, transmitting an indication that the dumb component is operating properly to the gaming machine master processing unit; and
upon determining that the dumb component of the multipart gaming machine peripheral is not connected and operating properly, transmitting an indication that the dumb component is not operating properly to the gaming machine master processing unit.

22. The machine-readable medium of claim 19, wherein the communication of the smart component with the gaming machine master processing unit is performed using a Universal Serial Bus (USB) protocol or an IEEE 1394 (Firewire) protocol.

23. The machine-readable medium of claim 19, wherein the communication of the smart component with the gaming machine master processing unit is performed using any plug-and-play capable data communication protocol.

24. The machine-readable medium of claim 19, wherein the dumb component can be blind-mated to the smart component.

25. The machine-readable medium of claim 19, wherein the multipart gaming machine peripheral is selected from the group including bill validators, coin hoppers, and coin mechanisms, printers, bill dispensers, bill hoppers, display devices, and cameras.

26. The machine-readable medium of claim 19, wherein the dumb component can be detached from the smart component for maintenance.
